(19) United States
(12) Patent Application Publication
(10) Pub. No.: US 2018/0018403 A1
(43) Pub. Date: Jan. 18, 2018

(54) METHOD AND SYSTEM FOR ANALYZING EMOTION ON BASIS OF POSITION RELATED DOCUMENT, AND NON-TRANSITORY COMPUTER-READABLE RECORDING MEDIUM

(71) Applicant: Konolabs, Inc., Seoul (KR)

(72) Inventors: Jung Hee Ryu, Seoul (KR); Joon Hee Kim, Seongnam-si (KR)

(73) Assignee: Konolabs, Inc., Seoul (KR)

(21) Appl. No.: 15/717,496

(22) Filed: Sep. 27, 2017

Related U.S. Application Data
(63) Continuation of application No. PCT/KR2015/008849, filed on Aug. 25, 2015.

(30) Foreign Application Priority Data
Jul. 15, 2015 (KR) 10-2015-0100570

(51) Int. Cl. G06F 17/30; H04W 4/02; H04L 29/08

(52) U.S. Cl. CPC G06F 17/30979; H04L 67/18; H04W 4/02

(57) ABSTRACT

According to one aspect of the present invention, provided is a method for analyzing an emotion on the basis of a position related document. The method includes generating a position related document with reference to content collected from at least one user terminal device or at least one server and position information related to the content; calculating an object-emotion score for each topic at positions related to the generated position related document; and determining, with reference to the object-emotion score for each topic at a first position, a predicted preference level of a user positioned at the first position with respect to at least one topic.

### CROSS-REFERENCE TO RELATED APPLICATION

This application is a continuation application of Patent Cooperation Treaty (PCT) international application Serial No. PCT/KR2015/008849, filed on Aug. 25, 2015, which claims priority to Korean Patent Application Serial No. 10-2015-0100570, filed on Jul. 15, 2015. The entire contents of PCT international application Serial No. PCT/KR2015/008849, and Korean Patent Application Serial No. 10-2015-0100570 are hereby incorporated by reference.

### FIELD OF THE INVENTION

The present invention relates to a method, system, and non-transitory computer-readable recording medium for analyzing emotions on the basis of a position-related document.

### BACKGROUND

Recently, a variety of position-based services using GPS, cellular networks, and the like have been introduced. Typical examples of the position-based services include a service for providing information related to a place where a user is currently positioned (e.g., information on a map, a shop, or the like), a navigation service for guiding a route from a current position to a destination, and a service for tagging position information to contents.

However, the conventional position-based services only consider a primary or direct relationship with the user's position in determining the service to be provided to the user. Thus, according to prior art, there is a limitation that it is difficult to provide a service which has a complex or indirect relationship with the user's position but may be very useful to the user.

### SUMMARY OF THE INVENTION

One object of the present invention is to solve all the above problems in prior art.

Another object of the invention is to generate quantified information on emotions that a user positioned at a predetermined position may feel, by generating a position-related document with reference to contents collected from a user terminal device or a server and position information related to the contents; calculating an object-emotion score for each topic at positions related to the generated position-related document; and determining, with reference to the object-emotion score for each topic at a first position, a preference that a user positioned at the first position is expected to have for at least one topic.

The representative configurations of the invention to achieve the above objects are described below.

According to one aspect of the invention, there is provided a method for analyzing emotions on the basis of a position-related document, comprising the steps of: generating a position-related document with reference to contents collected from at least one user terminal device or at least one server and position information related to the contents; calculating an object-emotion score for each topic at positions related to the generated position-related document; and determining, with reference to the object-emotion score for each topic at a first position, a preference that a user positioned at the first position is expected to have for at least one topic.

According to another aspect of the invention, there is provided a system for analyzing emotions on the basis of a position-related document, comprising: a position-related document management unit configured to generate a position-related document with reference to contents collected from at least one user terminal device or at least one server and position information related to the contents; and an emotion analysis unit configured to calculate an object-emotion score for each topic at positions related to the generated position-related document, and to determine, with reference to the object-emotion score for each topic a first position, a preference that a user positioned at the first position is expected to have for at least one topic.

In addition, there are further provided other methods and systems to implement the invention, as well as non-transitory computer-readable recording media having stored thereon computer programs for executing the methods.

According to the invention, it is possible to generate an object-emotion score for each topic with respect to significant positions on a map.

According to the invention, it is possible to generate quantified information on emotions that a user positioned at a specific place may feel.

### BRIEF DESCRIPTION OF THE DRAWINGS

FIG. 1 schematically shows the configuration of an entire system for analyzing emotions according to one embodiment of the invention.

FIG. 2 illustratively shows the internal configuration of an emotion analysis system according to one embodiment of the invention.

FIG. 3 illustratively shows how to generate a position-related document according to one embodiment of the invention.

FIGS. 4A and 4B illustratively show how to calculate an object-emotion score and a preference according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of an Entire System

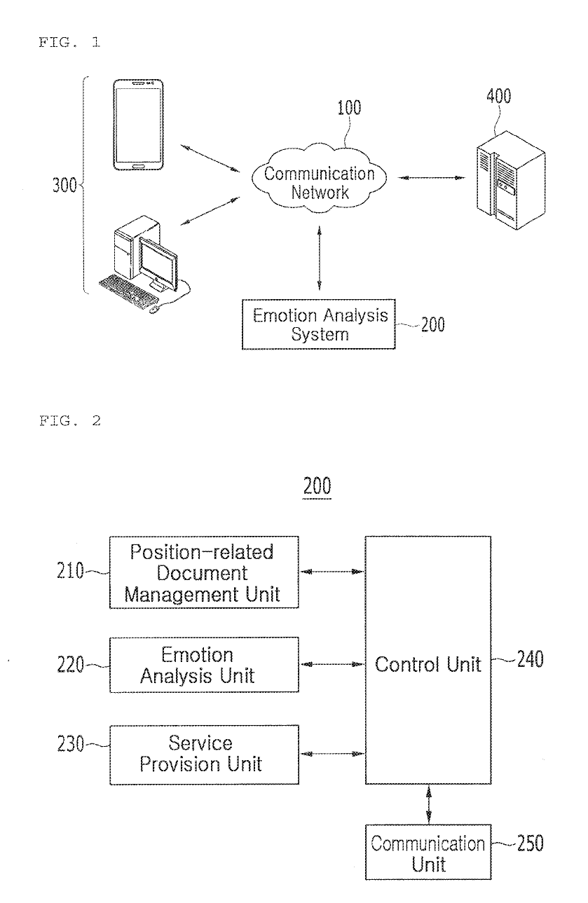

FIG. 1 schematically shows the configuration of an entire system for analyzing emotions according to one embodiment of the invention.

As shown in FIG. 1, the entire system according to one embodiment of the invention may comprise a communication network 100, an emotion analysis system 200, a user terminal device 300, and a server 4000.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the emotion analysis system 200 according to one embodiment of the invention may function to generate quantified information on emotions that a user positioned at a predetermined position may feel, by generating a position-related document with reference to contents collected from the user terminal device 300 or the server 400 and position information related to the contents; calculating an object-emotion score for each topic at positions related to the generated position-related document; and determining, with reference to the object-emotion score for each topic at a first position, a preference that a user positioned at the first position is expected to have for at least one topic.

The configuration and function of the emotion analysis system 200 according to the invention will be discussed in detail in the following description.

Next, according to one embodiment of the invention, the user terminal device 300 is digital equipment capable of allowing a user to connect to and then communicate with the emotion analysis system 200, and any type of digital equipment having a microprocessor and a memory means for computing capabilities, such as smart phones, tablets, desktop computers, notebook computers, workstations, personal digital assistants (PDAs), web pads, and mobile phones, may be adopted as the user terminal device 300 according to the invention.

Particularly, the user terminal device 300 may include an application (not shown) to assist a user to receive services from the emotion analysis system 200. The application may be downloaded from the emotion analysis system 200 or a known web server (not shown).

Next, according to one embodiment of the invention, the server 400 may function to provide position-related contents to the emotion analysis system 200 or the user terminal device 300. Specifically, the server 400 according to one embodiment of the invention may be a server operated by an entity providing a social network service (SNS) such as Twitter, Facebook, and Instagram which supports generation of position-related contents.

Configuration of the Emotion Analysis System

Hereinafter, the internal configuration of the emotion analysis system crucial for implementing the invention and the functions of the respective components thereof will be discussed.

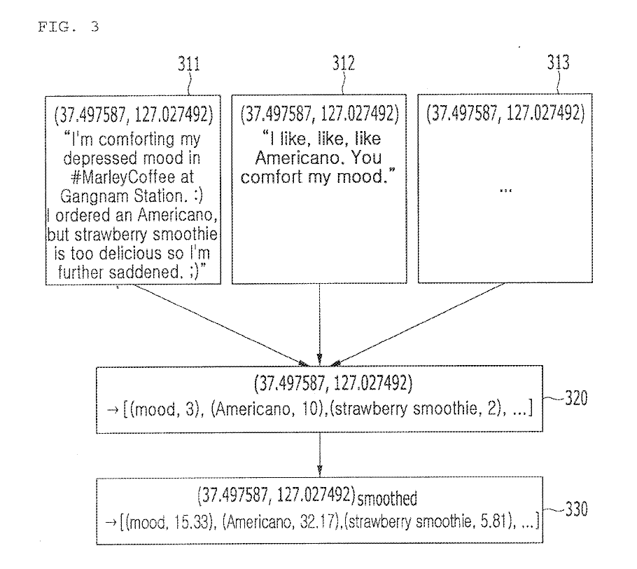

FIG. 2 illustratively shows the internal configuration of the emotion analysis system according to one embodiment of the invention.

Referring to FIG, 2, the emotion analysis system 200 according to one embodiment of the invention may comprise a position-related document management unit 210, an emotion analysis unit 220, a service provision unit 230, communication unit 240, and a control unit 250. According to one embodiment of the invention., at least some of the position-related document management unit 210, the emotion analysis unit 220, the service provision unit 230, the communication unit 240, and the control unit 250 may be program modules to communicate with an external system (not shown). The program modules may included in the emotion analysis system 200 in the form of operating systems, application program modules, and other program modules, while they may be physically stored in a variety of commonly known storage devices. Further, the program modules may also be stored in a remote storage device that may communicate with the emotion analysis system 200. Meanwhile, such program modules may include, but not limited to, routines, subroutines, programs, objects, components, data structures, and the like for performing specific tasks or executing specific abstract data types as will be described below in accordance with the invention.

First, according to one embodiment of the invention, the position-related document management unit 210 may collect various contents collected from at least one user terminal device 300 or at least one server 400 and position information related to the contents,

Specifically, according to one embodiment of the invention, the contents and the position information may be collected from social media. For example, posts containing position information such as geo-tagged tweets, articles containing place information such as reviews of restaurants, and the like may be collected.

Further, according to one embodiment of the invention, the position information related to the contents may be specified on a two-dimensional coordinate system defined by latitude and longitude. Thus, according to one embodiment of the invention, a large number of contents collected from social media may be mapped onto the two-dimensional coordinate system according to the position information related thereto.

FIG. 3 illustratively shows how to generate a position-related document according- to one embodiment of the invention.

Referring to FIG. 3, a variety of contents 311, 312, 313 related to two-dimensional coordinates of (37.497857, 127.027492) may be collected, such as “I'm comforting my depressed mood in #MarleyCoffee at Gangnam Station. :) I ordered an Americano, but strawberry smoothie is too delicious so I'm further saddened. ;)” and “I like, like, like Americano. You comfort my mood.”

Further, according to one embodiment of the invention, the position-related document management unit 210 may function to generate at least one position-related document with reference the contents and the position information collected as above.

Specifically, according to one embodiment of the invention, the position-related document may include information on a word contained in the contents related to the position information and a number of times the word appears.

In this connection, referring to FIG. 3, a position-related document generated in relation to the position (37.497857, 127.027492) may be generated as “(37.497857, 127,027492)→(mood, 3), (Americano, 10), (strawberry smoothie, 2), . . .]” (320).

Further, according to one embodiment of the invention, the position-related document management unit 210 may function to perform a smoothing process on two or more position-related documents commonly falling within a category predetermined on the basis of positions or generation times, thereby incorporating the two or more position-related documents. Thus, it is possible to incorporate a plurality of position-related documents, which may be considered to be related to substantially the same position or place although there are slight differences, into a single position-related document.

According to one embodiment of the invention, a known smoothing algorithm may be used to perform a smoothing process on the position-related document.

As one example of the smoothing algorithm, the position-related document management unit 210 according to one embodiment of the invention may incorporate a second position-related document into a first position-related document such that a greater weight is given to the second position-related document as the difference between the positions or generation times of the first and second position-related documents is smaller.

An example of using a smoothing algorithm for giving distance-based weights among known smoothing algorithms will be described in more detail below.

It may be assumed that a first position-related document Dx,y generated in relation to a first position (x, y) incorporates (i.e., merges) a second position-related document Dx′,y′ generated in relation to a second position (x′, y′). In this case, with respect to a word contained in Dx′,y′ but not in Dx,y, the position-related document management unit 210 according to one embodiment of the invention may newly add the word and the corresponding number of times the word appears to Dx,y, and with respect to a word contained in Dx′,y′ and Dx,y, it may add a value corresponding to the number of times the word appears in Dx′,y′ divided by the distance between (x, y) and (x′, y′) to the number of times the word appears in Dx,y.

However, it is noted that the smoothing algorithm used in the invention is not necessarily limited to the foregoing, and may be changed without limitation as long as the objects of the invention may be achieved.

In this connection, referring to FIG. 3, the incorporated position-related document, which result from the smoothing process performed on a plurality of position-related documents generated in relation to the position (37.497857, 127.027492) and nearby positions, may be generated as “(37.497857, 127.027492)→[(mood, 15.33), (Americana, 32.17), (strawberry smoothie, 5.81), . . . ]” (330).

Next, according to one embodiment of the invention, the emotion analysis unit 220 may function to calculate an object-emotion score for each topic at positions related to the position-related document generated as above.

Specifically, according to one embodiment of the invention, a topic may be defined on the basis of words contained in the above-described position-related document, and may be generated by a known natural language processing algorithm or artificial intelligence algorithm. It is noted that the natural language processing algorithm or artificial intelligence algorithm used to generate a topic in the invention may be changed without limitation as long as the objects of the invention may be achieved.

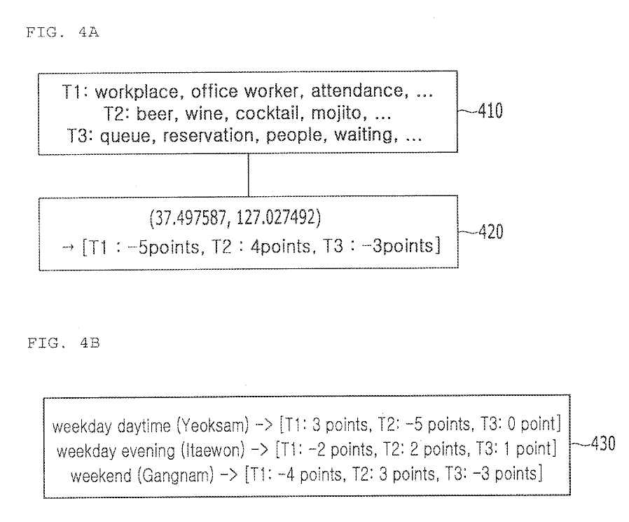

FIGS. 4A and 4B illustratively show how to calculate an object-emotion score and a preference according to one embodiment of the invention.

Referring to FIG. 4A, topics T1, T2, and T3 may be generated on the basis of words contained in various position-related documents respectively generated in relation to various positions. Here, the topic T1 may be specified by “workplace, office worker, boredom, . . . ”, the topic T2 may be specified. by “beer, wine, cocktail, mojito, . . . ”, and the topic T3 may be specified by “queue, reservation, people, waiting, . . . ” (410).

Further, according to one embodiment of the invention, an object-emotion score indicates what emotion has been expressed for a particular topic in a large number of contents generated in relation to a specific position. For example, a high score may be calculated when it is analyzed that a positive emotion has been expressed, and a low score may be calculated when it is analyzed that a negative emotion has been expressed.

The above object-emotion score may be calculated by a known emotion analysis algorithm. As one example of the emotion analysis algorithm, an emotion analysis algorithm described in a paper entitled “Aspect and Sentiment Unification Model for Online Review Analysis”, which was authored by Yohan Jo and Alice H. Oh and published in Proceedings of the Fourth ACM International Conference on Web Search and Data Mining, ACM, 2011, may be employed. However, it is noted that the emotion analysis algorithm used in the invention is not necessarily limited to the foregoing, and may be changed without limitation as long as the objects of the invention may be achieved.

Referring to FIG. 4A, the object-emotion score at the position (37.497857, 127.027492) (indicating Gangnam Station) may be calculated as [T1: −5 points, T2: 4 points, T3: −3 points] (420). It may be determined from the object-emotion score that in the contents generated in relation to Gangnam Station, there axe a high tendency for negative emotions to be expressed for the topics T1 and T3, and a low tendency for positive emotions to be expressed for the topic T2.

Further, according to one embodiment of the present invention, the emotion analysis unit 220 may function to determine, with reference to an object-emotion score for each topic at a specific position, a preference that a user positioned at the specific position is expected to have for at least one topic,

Referring to FIG. 4B, it may be assumed that a user is positioned in Yeoksam, Itaewon, and Gangnam in a weekday daytime, a weekday evening, and a weekend, respectively. In this case, the emotion analysis unit 220 according to one embodiment of the invention may expect, with reference to the object-emotion scores calculated for Yeoksam, Itaewon, and Gangnam, that a preference for the topic T1 is high on the weekday daytime when the user is positioned at Yeoksam, a preference for the topic T2 is high on the weekday evening when the user is positioned at Itaewon, and a preference for the topic T2 is high on the weekend when the user is positioned at Gangnam (430).

Specifically, according to one embodiment of the invention, the emotion analysis unit 220 may correct the preference determined as above on the basis of the user's actual route. For example, when the user frequently visits a restaurant falling within the topic T1 even though the user is expected to have a low preference for the topic T1, the emotion analysis unit 220 according to one embodiment of the invention may correspondingly make a correction to increase the user's preference for the topic T1.

Next, according to one embodiment of the invention, the service provision unit 230 may function to determine information to be recommended for a user positioned at a specific position (e.g., information on places, foods, performances, schedule recommendation, and the like), with reference to the user's preference for each topic determined as above.

Meanwhile, the communication unit 240 according to one embodiment of the invention may function to enable the emotion analysis system 200 to communicate with an external device such as the user terminal device 300.

Lastly, the control unit 250 according to one embodiment of the invention may function to control data flow among the position-related document management unit 210, the emotion analysis unit 220, the service provision unit 230, and the communication unit 240. That is, the control unit 250 may control inbound data flow or data flow among the respective components of the emotion analysis system 200, such that the position-related document management unit 210, the emotion analysis unit 220, the service provision unit 230, and the communication unit 240 may carry out their particular functions, respectively.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as bard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for analyzing emotions on the basis of a position-related document, comprising the steps of:
generating a position-related document with reference to contents collected from at least one user terminal device or at least one server and position information related to the contents;
calculating an object-emotion score for each topic at positions related to the generated position-related document; and
determining, with reference to the object-emotion score for each topic at a first position, a preference that a user positioned at the first position is expected to have for at least one topic.

2. The method of claim 1, wherein the contents and the position information are collected from social media.

3. The method of claim 1, wherein the position information is specified by latitude and longitude.

4. The method of claim 1, wherein the position-related document includes information on a word that appears in relation to the position information and a number of times the word appears.

5. The method of claim 1, wherein in the step of generating a position-related document, a smoothing process is performed on two or more position-related documents commonly falling within a category predetermined on the basis of positions or generation times, thereby incorporating the two or more position-related documents.

6. The method of claim 5, wherein in the step of generating a position-related document, when a second position-related document is incorporated into a first position-related document, a greater weight is given to the second position-related document as a difference between the positions or generation times of the first and second position-related documents is smaller.

7. The method of claim 1, wherein the topic is defined on the basis of words contained in the generated position-related document.

8. The method of claim 1, wherein the determined preference is corrected on the basis of the user's actual route.

9. The method of claim 1, further comprising the step of:
determining information to be recommended for the user positioned at the first position, with reference to the determined preference.

10. A non-transitory computer-readable recording medium having stored thereon a computer program for executing the method of claim 1.

11. A system for analyzing emotions on the basis of a position-related document, comprising:
a position--related document management unit configured to generate a position-related document with reference to contents collected from at least one user terminal device or at least one server and position information related to the contents; and
an emotion analysis unit configured to calculate an object-emotion score for each topic at positions related to the generated position-related document, and to determine, with reference to the object-emotion score for each topic at a first position, a preference that a user positioned a first position is expected to have for at least one topic.

12. The system of claim 11, wherein the contents and the position information are collected from social media.

13. The system of claim 11, wherein the position-related document includes information on a word that appears in relation to the position information and a number of times the word appears.

14. The system of claim 11, wherein the position-related document management unit performs a smoothing process on two or more position-related documents commonly falling within a category predetermined on the basis of positions or generation times, thereby incorporating the two or more position-related documents.

15. The system of claim 11, further comprising:
a service provision unit configured to determine information to be recommended for the user positioned at the first position, with reference to the determined preference.
